(19) United States
(12) Patent Application Publication
(10) Pub. No.: US 2025/0022035 A1
(43) Pub. Date: Jan. 16, 2025

(54) Kid's Bag and Method of Organizing the Kid's Bag

(71) Applicants: Kayla Marie Patel; Jill Petrosillo Matthew, Valley Lee, MD (US)

(72) Inventors: Kayla Marie Patel; Jill Petrosillo Matthew, Valley Lee, MD (US)

(21) Appl. No.: 18/221,296

(22) Filed: Jul. 12, 2023

(51) Int. Cl. G06Q 30/0601; G06Q 30/0203

(52) U.S. Cl. CPC G06Q 30/0631; G06Q 30/0203

(57) ABSTRACT

A kid's bag, to be named, the Kid Go Bag contains a personalized collection of objects to address a child's needs and wants when the child is out in a public setting. The Kid Go Bag has an assortment of objects that occupy and engages children based on their development; supports continued development of children; and provides additional support, as needed, to sensory and emotional regulation for children. The kid's bag is personalized by a method that questions the parent's observations and known educational factors.

### FIELD OF THE INVENTION

The present invention relates to educational growth of a child's stimulation based on a questionnaire. In addition, the invention relates to customized bags for children and a method for improving children's development and improving family outings through the occupation of play using the customized bag.

### BACKGROUND OF THE INVENTION

Screen Time: It is customary for parents to give the children a tablet or smart phone to keep their children entertained while being out to a restaurant or a public gathering. Phones or tablets are increasing that child's screen time and making them dependent on electronic devices thus decreasing fine motor skills, decreasing creativity, and decreasing social skills. No other option has been found that provides a decision tree to create a custom collection of developmentally appropriate and occupational therapist (OT), approved objects for a child.

No Phone: There is nothing fulfilling than not to give kids a phone. Excessive screen time does not help a child's develop and parents feel guilty increasing their child's screen time. According to David Hill et al., “Children younger than 2 years need hands-on exploration and social interaction with trusted caregivers to develop their cognitive, language, motor, and social-emotional skills”. When parents resort to using phones, at outings with their children, parents inevitably hinder their children's development. It is a common misunderstanding that phones and apps can be educational to children. In 2016, Hill et al. concluded that “Because of their immature symbolic, memory, and attentional skills, infants and toddlers cannot learn from traditional digital media as they do from interactions with caregivers”. Hill et al. also state that “Population-based studies continue to show associations between excessive television viewing in early childhood and cognitive, language, and social/emotional delays”. The aforementioned research supports that children need developmentally appropriate objects to keep them occupied during outings instead of screen time.

No More Screen Time: According to Auxier et al., “Parents with young children themselves make clear they are anxious about the effects of screen time. 71% of parents of a child under the age of 12 say they are at least somewhat concerned their child might ever spend too much time in front of screens, including 31% who are very concerned about this. Some parents with a child in this age range already believe their child spends too much time on certain devices, including a smartphone”. Most parents do not want to increase the screen time for their child; however, in public places there are often no better options.

Effects of Phones on Child Development: According to Hill et al. (2016), “Children younger than 2 years need hands-on exploration and social interaction with trusted caregivers to develop their cognitive, language, motor, and social-emotional skills”. When parents resort to using phones to go on outings, they inevitably hinder their children's development. It is a common misunderstanding that phones and apps can be educational to children. In 2016, Hill et al. states that “It is important to emphasize to parents that the higher-order thinking skills and executive functions essential for school success, such as task persistence, impulse control, emotion regulation, and creative, flexible thinking, are best taught through unstructured and social (not digital) play, as well as responsive parent-child interactions”. The goal of our process is to provide a personalized collection of objects to progress each child's development.

Taking Kids Out: Taking children out into public places, such as going to a restaurant can be stressful. This stress affects the caregivers and the children according to Azhari et al. (2019). The study demonstrates the adverse effect of parenting stress on mother-child attunement that is evident at a brain-to-brain level. Mother-child brain-to-brain asynchrony may underlie the robust association between parenting stress and poor dyadic co-regulation.

Current Products: Some companies offer premade bags or collections of toys for children when out in public; however, these collections are not personalized. These companies offer one type of bag based on the child's age only. It is known that every child develops differently. The toys and objects that engage a certain two-year old may look very different from the things that engage another two-year old. Very Busy Bag at verybusybag.com, The Ultimate Quiet Book for Toddlers sold by Quiet Book Club, LLC at amazon.com, Mystery bag sold by busybebes.com, Keke Bags at kekekid.com along with their Pouch Subscription, KiwiCo, LoveEvery, and GoGoBusyBags, are options for parents to take with them; however, none of these are personalized to each child or their stage of development. “Since brain development after birth is influenced by inputs from the environment, and because those inputs are unique to each child, every human brain is unique” (Semrud-Clikeman, 2015). Semrud-Clikeman also concluded that “all brain functions do not mature at the same rate”.

Definitions: Developmental milestones are “a set of functional skills or age-specific tasks that most children can do at a certain age.” Child development refers to how a child becomes able to do more complex things as they get older. Development is different than growth. Growth only refers to the child getting bigger in size. When we talk about normal development, we are talking about developing skills like:
Gross motor skills: using large groups of muscles to sit, stand, walk, run, etc., keeping balance and changing positions;
Fine motor skills: using hands to be able to eat, draw, dress, play, write, and do many other things;
Language skills: speaking, using body language and gestures, communicating, and understanding what others say;
Cognitive skills: thinking skills including learning, understanding, problem-solving, reasoning, and remembering; and,
Social skills: interacting with others, having relationships with family, friends, and teachers, cooperating and responding to the feelings of others.

### SUMMARY OF THE INVENTION

The present invention relates to a process for providing a custom bag of easily transported, developmentally, appropriate objects to improve fine motor, social, play and imaginative skills for children based on a questionnaire filled by parents. Based on the parent's input, the custom bag is created. The custom bag decreases screen time and is something that parents can feel good handing to their child to keep them occupied during outings in public places.

A child's development includes time spent on outings with parents. The customized bag, to be named The Kid Go Bag, is a collection of items to assist parents and their children when going out and about and simultaneously enhance their child's development. The Kid Go Bag provides children with items that meet them at their developmental level, that provide a just right challenge and encourage continued child development, and that keep children occupied and engaged to improve family outings for both children and their parents. A survey, questionnaire, or decision tree, filled online or in person, provides information needed on what types of items occupy the child best needs, determines the child's developmental play level, and questions about any additional sensory needs to be addressed during outings. Parents or guardians can use the collection of items to improve their child's behavior during outings by keeping them occupied and thereby improving the parent or guardian's experience of the outing. The parent or guardian may also update the questionnaire or survey as their child changes to adjust to their needs.

### BRIEF DESCRIPTION OF THE DRAWINGS

FIG. 1 is a flow chart to determine fine motor skills of children.

FIG. 2 is a flow chart to determine cognitive skills of children.

FIG. 3 is a flow chart to determine literacy of children.

FIG. 4 is a questionnaire to determine additional interests of children.

FIG. 5 is a comparison chart between three parents about their children's reaction.

### DETAIL DESCRIPTION OF THE DRAWINGS

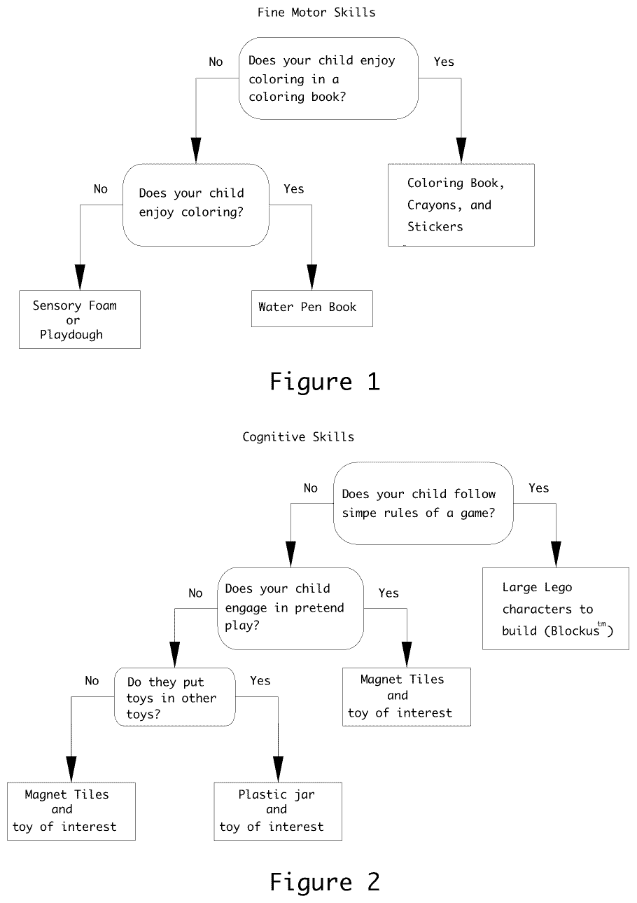

FIG. 1 shows an exemplary collection of items to work on their fine motor skills that includes toys to keep children occupied and thereby improve parent and child experiences during outings.

FIG. 2 shows an exemplary collection of items to work on the children's cognitive skills.

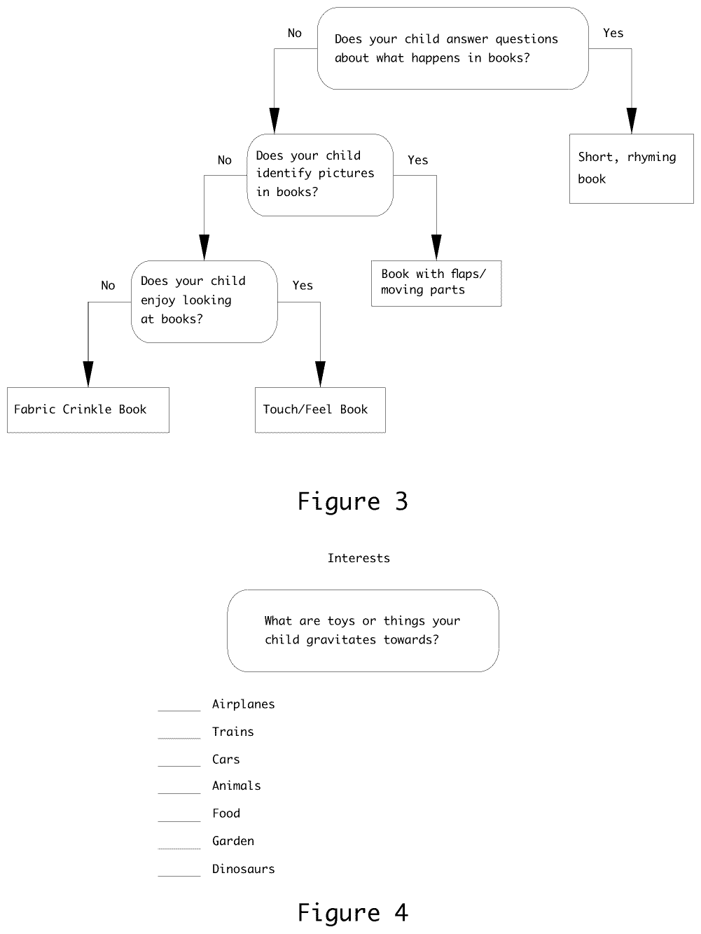

FIG. 3 shows an exemplary collection of items to work on the children's literacy skills.

FIG. 4 shows an exemplary collection of items to work on the children's interest.

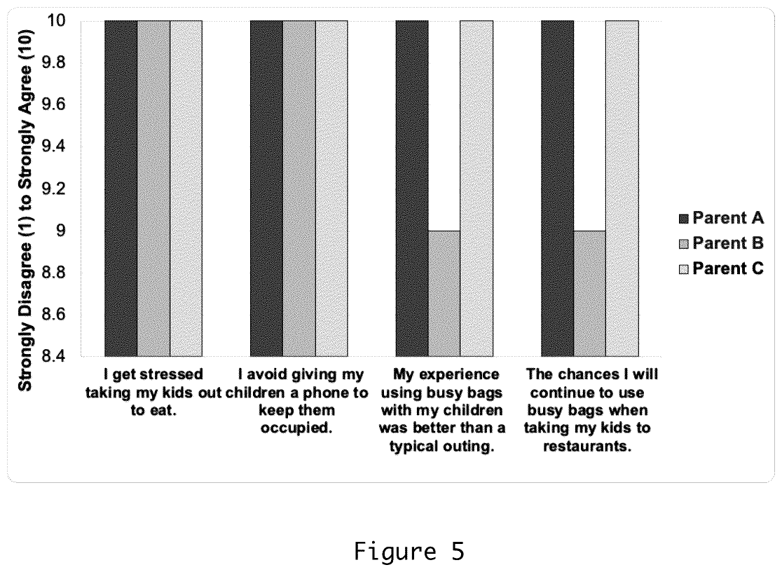

FIG. 5 shows a qualitative chart of three parents. After using the kid's bag, Parent A indicated, “I love the idea of the Kid's Go Bag!! Overall I think it was very helpful and the unique toys that the boys hadn't seen were very engaging for them”.

“The fact that the toys were personalized was definitely key! Also having a book besides the toys give them the chance to be quiet (if they need a break from being busy). I also like the variety of toys, since their spam of attention gets a little lost easily.”

Parent B reports following trialing the Kid Go Bag was that they will continue to utilize the bags for their purpose and look forward to less stressful outings with their children. The results of our data collection for parent B confirms that the Kid Go Bag increases the time that families can spend at restaurants, increases the time that children at engaged, and decreases stress for parents.

Conclusion: At the start of this research, it was expected that toddlers who participated would spend more time at the table and have better toddler and parent experiences when utilizing the Kid Go Bag.

The quantitative and qualitative data gathered during the trials indicated that with the Kid Go Bag, parents had a vastly improved experience eating out with their children and would use the Kid Go Bag again.

The results of these trials suggest that the use of Kid Go Bag with toddlers improves their experience eating out as well as improves their parents' experience.

It is envisioned that the invention can be applied to siblings so that if one child has a specific object in the bag, that same object is typically wanted by the sibling. A bag designed for another siblings is to include one of the same objects so each bag is the same. This option is for families with siblings to avoid fighting between siblings.

1. A method of determining a personalized set of items for a child into a bag comprising the steps of:
providing a first questionnaire to determine motor skills;
providing a second questionnaire to determine cognitive skills; and,
providing a third questionnaire to determine literacy.

2. The method of claim 1, wherein the step of providing the first questionnaire comprising using knowledge of developmental milestones.

3. The method of claim 1, wherein the steps of providing the first questionnaire, the second questionnaire, and the third questionnaire comprising using knowledge of developmental milestones.

4. The method of claim 1, further comprising the step of providing a fourth questionnaire to determine the child's personal interests.

5. The method of claim 1, further comprising the step of independently accessing the objects by the child.

6. The method of claim 2, further comprising the step of independently accessing the objects by the child.

7. The method of claim 3, further comprising the step of independently accessing the objects by the child.

8. The method of claim 4, further comprising the step of independently accessing the objects by the child.
